(19) United States
(12) Patent Application Publication
(10) Pub. No.: US 2026/0031649 A1
(43) Pub. Date: Jan. 29, 2026

(54) BACK-UP POWER SOURCE SYSTEM FOR COLD ENVIRONMENTS

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 19/281,690

(22) Filed: Jul. 27, 2025

Related U.S. Application Data
(60) Provisional application No. 63/676,662, filed on Jul. 29, 2024.

(51) Int. Cl. H02J 9/06; H01G 11/18; H01M 10/44; H01M 10/46; H01M 10/48; H01M 10/615; H01M 10/637; H02J 7/00; H02J 7/34

(52) U.S. Cl. CPC H02J 9/061; H01G 11/18; H01M 10/443; H01M 10/46; H01M 10/486; H01M 10/615; H01M 10/637; H02J 7/0047; H02J 7/0068; H02J 7/345; H02J 2207/50

(57) ABSTRACT

A method including: monitoring a power supply from a line power source; monitoring a temperature of one or more of a battery and a super-capacitor, when power is available through the line power source: supplying power directly from the line power source to the supported system; and supplying power directly to the charger to charge the battery and the super-capacitor, and in the event of a detected line power outage, supplying power to the supported system from one or more of the battery and super-capacitor based at least on the detected temperature of the one or more of the battery and super-capacitor.

### CROSS REFERENCE TO RELATED APPLICATION

This application claims the benefit of U.S. Provisional Application No. 63/676,662, filed on Jul. 29, 2024, the entire contents of which is incorporated herein by its reference.

### BACKGROUND

### Field

This disclosure is directed to methods and devices for the development of back-up power sources using batteries that would optimally function in cold environments without requiring external heating to keep the battery at or close to its optimal operational temperature, in particular, to provide methods for the development of battery-based back-up power sources that can function at peak performance level in cold environments without requiring electrically operated heating sources, such as heating pads or the like to keep the batteries at or close to their operating temperature. The methods and devices would provide battery-based back-up power source systems that require minimal cost to operate and can be constructed using almost any type of rechargeable batteries.

### Prior Art

A backup power source, also known as an uninterruptible power supply (UPS), is a system that provides power when the primary source of power fails. Backup power sources are important for many areas where reliable equipment operation is essential, such as hospitals, data centers, and factories.

Many backup power sources are used for indoor use, such as those for computers, and hospital equipment, etc., which means that they are not exposed to low temperatures. However, backup power sources that are used for systems such as telecommunications towers, including cell towers, and other systems that may at times be subjected to their power line outages while the environment is at low temperature require the means of keeping their batteries at their optimal temperature so that in the event of a power line outage, the system could continue to operate properly.

It is well known that the performance of batteries is significantly reduced at low temperatures. This is the case for both primary and rechargeable batteries. In addition, current lithium-ion and Lithium-polymer battery technology does not allow battery charging at temperatures below zero degrees C. and charging at temperatures below their optimal level has been shown to reduce battery life. The amount of electrical energy that Lithium-ion, Lithium-polymer, and other similar batteries, which are generally preferred in many such applications, including for telecommunication and cell towers, can provide when fully charged is reduced drastically even at temperatures that are 5-10 degrees C.

Telecommunications towers, including cell towers, often have backup power sources to ensure uninterrupted power supply and communication transmission. The Federal Communications Commission (FCC) requires cell phone and landline carriers to install backup power supplies at all their sites, with a minimum of eight hours of backup for assets that are normally powered by local commercial power. However, areas that are prone to extended power outages, such as those at-risk during hurricanes, may need a backup capability of 24 to 72 hours.

To maintain a reliable supply of electricity, telecom towers are often connected to the grid and often have backup power sources such as batteries, diesel generators, or renewable energy systems. To ensure uninterrupted power supply to telecom towers, automatic reclosers play a vital role. The auto recloser is an intelligent device installed on the power line to protect the cable line from faults and automatically restore the power supply. A circuit breaker automatically recloses the circuit after a fault has been removed, restoring power to downstream equipment.

Backup power sources for telecommunications and cell towers can include:
Diesel or other internal combustion-based generators: A reliable backup power source that uses diesel fuel stored in tanks that are not affected by utility outages. Diesel generators are versatile, have a longer runtime, and can provide continuous power without frequent refueling. These generators would still require battery or capacitor bank back-up power sources to provide uninterruptible power while the generators are turned on and begin to provide the required power.
Batteries: Provide uninterruptible power.
Renewable energy systems: Such as solar photovoltaic panels, wind turbines, fuel cells, and microturbines. These systems can help reduce the consumption of fossil fuels and carbon emissions.

In any one of the above methods of providing backup power to a system such as telecommunication and cell towers, when power outage occurs, power must be provided to the system without interruption. For this reason, battery-based backup power sources are generally used. However, when the environmental temperature is low, depending on the battery type being used, the backup power source batteries can only provide a fraction of their available electrical energy. For example, when the environmental temperature is even at 5-10 degrees, Lithium-ion and Lithium-polymer and all so-called solid-state batteries can provide a fraction of their stored electrical energy and at −10 to −20 degrees their available power become very low and could effectively considered ineffective in most practical applications.

Similar low temperature issues are faced with all currently available batteries, noting that it is always desirable to use high energy density batteries in many applications, such as in telecommunication and cell tower and emergency signal applications. This is the case since for logistics and practical reasons, batteries such as Lithium-ion and Lithium-polymer batteries that provide high energy density and would therefore yield lighter back-up power source weight are highly desirable.

Current solutions that try to address cold weather effects on back-up power source batteries include heating the exterior of the battery by using electrical heating pads or heating blankets, or recently by embedding heating elements inside the batteries. In addition, a recently developed technology uses high frequency current to directly heat battery electrolyte and super-capacitors.

The main disadvantage of all currently available methods and means of keeping back-up battery temperature within an optimal range in cold environments that would ensure efficient operation of the batteries in providing power to the system to be powered once the line power has been shut down is that they require to always keep the batteries warm and within their prescribed temperature range. It is appreciated that the line power may become unavailable only during a short period of minutes, hours or at most days during the entire cold seasons or during the evenings and nights in most regions of the world and even at locations that the temperature is always below the required range for the batteries being used in the power source. In fact, this is even the case when even the case when diesel or the like generators are used as the primary backup power source since they also require providing uninterrupted power to the intended system using battery-based power while their electrical power becomes available to the system.

It is appreciated that the above requirement of always keeping batteries of battery-based back-up power sources warm, while they are only needed when line power is lost for minutes, hours or at most days, and since such line power loss occurs very seldomly, usually only at most one or two times during cold seasons or during extreme weather conditions even in very cold regions, therefore current methods and devices that keep batteries of back-up power sources warm at all times are obviously wasting a very large amount of electrical energy in keeping the batteries warm when they are not needed, that is most of the times.

It is also appreciated that battery-based back-up power sources may use almost any secondary batteries, such as Lithium-ion, Lithium-polymer, NiMH and Lead-acid batteries. In only very limited applications, the back-up power sources may be provided with primary batteries. In addition, in certain relatively low power applications, super-capacitors may be used in place of batteries.

The discharge performance of all batteries is decreased at low temperatures. For example, at −40° C., commercial 18650 Li-ion batteries can only deliver 5% of the energy density, and 1.25% of the power density than at 20° C. (G. Nagasubramanian, “Electrical characteristics of 18650 Li-ion cells at low temperatures,” Journal of Applied Electrochemistry, vol. 31, pp. 99-104, 2001). This also applies to Li-polymer and other similarly designed batteries. The decrease in the ionic conductivity of the electrolyte and the solid electrolyte interface (SEI) layer; and the limited diffusivity of Lithium ions within the graphite anode electrodes are not the only contributors to the poor low temperature performance. In fact, when the temperature falls below −10° C., the dominant component is the slow kinetics of the battery reactions (S. S. Zhang, K. Xu and T. R. Jow, “The low temperature performance of Li-ion batteries,” Journal of Power Sources, vol. 115, pp. 137-140, 2003). Therefore, solutions that call for the use of more ionically conductive electrolytes, or additives to improve the anode electrode conductivity to improve low temperature performance are not good enough solutions at very low temperatures. The thermodynamics of the Lithium ions intercalation/de-intercalation process and the kinetics of the redox reactions ultimately determine the maximum possible discharge capacity of a lithium-ion battery at low temperatures.

Charging a standard Li-ion and Li-polymer and other similar batteries below 0° C. must always be avoided. During the charging process, the low temperature causes the negative electrode's lattice to contract, leaving insufficient space for lithium ions to intercalate. In addition, the charge transfer and solid-phase diffusion processes slow down significantly at low temperatures. This results in the formation of lithium metal deposits (e.g., Lithium plating) on the surface of the negative electrode. The formation of lithium metal deposits causes irreversible loss of battery capacity since this fixed lithium is not available any longer during the discharge step. The larger the charging current, the more severe the damage to the electrode structure, and the faster the battery loses irreversible capacity. Further, the non-homogeneous growth of lithium metal deposits can easily form lithium dendrites that can grow large enough to puncture through the polymeric separator and short the battery, causing internal hot spots and potential for a fire or explosion of the battery.

It has been widely reported (for example, Waldman, T, M. Kasper, M. Wilka, M. Fleischammer and M. Wohlfahrt, “Temperature dependent aging mechanisms in Lithium-ion batteries-A Post-Mortem study,” Journal of Power Sources, vol. 262, pp. 129-135, 2014), that commercial 18650-type Li-ion batteries age significantly faster when they are operated in low temperature conditions. FIG. 1 illustrates the effect of temperature on the number of charge/discharge cycles before the state of health (SOH) of the battery drops below 80%. The aging rate increases exponentially (Arrhenius dependency) with a drop in temperature. For example, if a battery is continuously operated at 5° C., the number of cycles before it reaches an 80% SOH is only 10% than if the battery is operated at 25° C.

The standard Li-ion battery electrolyte consists of mixtures of two liquid organic carbonates (e.g., 50% mol fraction of ethylene carbonate EC, 50% mol fraction of ethyl methyl carbonate, EMC), and a Lithium salt (e.g., Lithium hexafluoro phosphate, LiPF₆). On their own, EC and EMC freeze at 35.5° C., and at −53.5° C., respectively. FIG. 2 shows the liquidus point of mixtures of EC+EMC (M. S. Ding, X. Kang and R. Jow, “Liquid-Solid Phase Diagrams of Binary Carbonates for Lithium Batteries,” Journal of the Electrochemical Society, vol. 147, no. 5, pp. 1688-1694, 2000). The liquidus point of a 50% vol. EC/EMC mixture is around 10° C. The addition of IM LiPF₆ Lithium salt depresses the liquidus point down to −10° C. In fact, this is the recommended low temperature usable range of lithium-ion batteries, because if the temperature is dropped below the liquidus point, the first solids of electrolyte start to appear. As the temperature is further decreased, more and more solids form until the entire electrolyte volume freezes solid below −60° C. If the temperature is increased, battery capacity is recovered as the electrolyte remelts. However, small amounts of the Lithium salt LiPF₆ might remain undissolved in the liquid electrolyte. Thus, with every freezing-thawing cycle, the battery loses some capacity as more and more LiFP6 salt remains undissolved. Therefore, if a battery is regularly exposed to very low temperatures, even without being used, it will eventually lose all capacity.

### SUMMARY

It is appreciated that current methods of keeping batteries of back-up power sources warm (hereinafter, the term warm is intended to indicate the range of temperature at which the battery can provide power at its optimal level and is also optimal for their charging) waste a very large amount of electrical energy to keep the batteries warm at all times during cold weathers so that they can be used at their optimal performance level at generally very few relatively short periods that they are needed to provide electrical energy to the intended system when line power to the system has been cut due to some usually climate activity. For example, in northern parts of New York state, in the 1991-2020 period, on average, around 165 days experienced below freezing (32 degrees F.-0 degrees C.) temperatures and around 86 days below 20 degrees F. (−6.7 degrees C.) (from: www.midatlanticrisa.org/data-tools/climate-data-tool/average-annual-cold-days.html). It is appreciated that batteries such as Lithium-ion or Lithium-polymer that are commonly used in back-up power sources do not provide full power even at 5-10 degrees C. and if used at these temperatures, their life cycle would be degraded significantly. This means that for over half the year, the back-up power source batteries have to be heated so that for one or two times that they may be needed to power a cell tower or the like for a few minutes, hours or on most days, they can provide the needed power.

It is therefore highly desirable to develop methods and related devices that would perform the above function of the currently available battery-based back-up power sources, but without requiring continuous heating of the power source batteries when the environmental temperature drops below certain level, for example below 15 degrees C. for Lithium-ion and Lithium-polymer batteries and below zero degree C. for Lead-acid batteries. Such battery-based back-up power sources would provide uninterruptible power to the intended system in cold environments without requiring continuous heating of the batteries to bring them to their optimal operating temperature, thereby would significantly reduce the amount of required electrical energy to power the power source and the related costs.

There is therefore a need for methods and devices for always keeping batteries of battery-based back-up power sources ready to provide uninterrupted power at their peak level when line power is shut down without notice, particularly in cold and even extremely cold environments of below −40 degrees C. without requiring heating to keep the battery temperature at its optimal operational level at all times. Such methods and devices would significantly reduce the operational cost of the power sources and with great savings the required electrical energy to always keep the batteries warm.

Accordingly, methods and systems are provided that can be used to construct battery-based back-up power sources that can provide uninterrupted power to the intended line-powered systems and devices in all environmental conditions, including cold and extremely cold environments without requiring the batteries to be always kept warm.

Accordingly, methods and systems are provided that can be used to construct battery-based back-up power sources that can provide uninterrupted power to the intended line-powered systems and devices in all environmental conditions, including cold and extremely cold environments without requiring the batteries to be always kept warm. The methods and systems do not require the power source batteries to be kept at their optimal operational temperature at all times, thereby significantly reducing the amount of electrical energy that is needed to keep the power source ready to provide uninterrupted power to the intended system in case of line power outage. The related operational cost of the power source is thereby significantly reduced, and a large amount of electrical energy is saved.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates the plot of State of Health (SOH) of 18650 Li-ion batteries vs. number of cycles as a function of operating temperature.

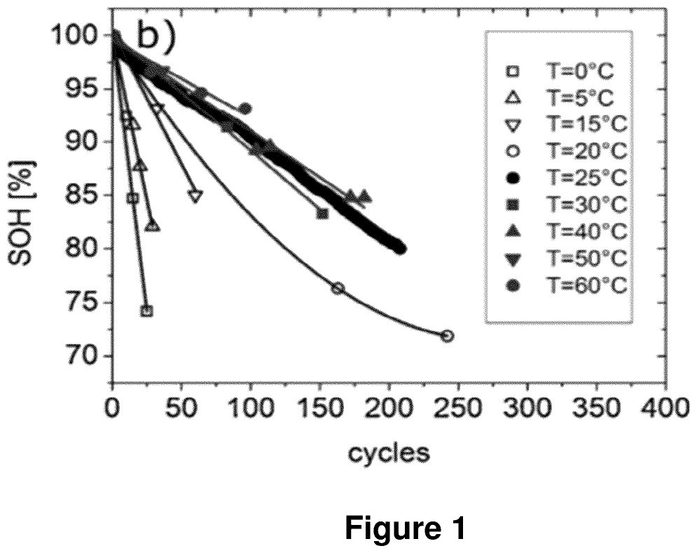

FIG. 2 illustrates the liquid-solid phase diagram of EMC-EC. The closed dots represent measured data for three different solutions of LiPF6 in an EMC-EC solvent.

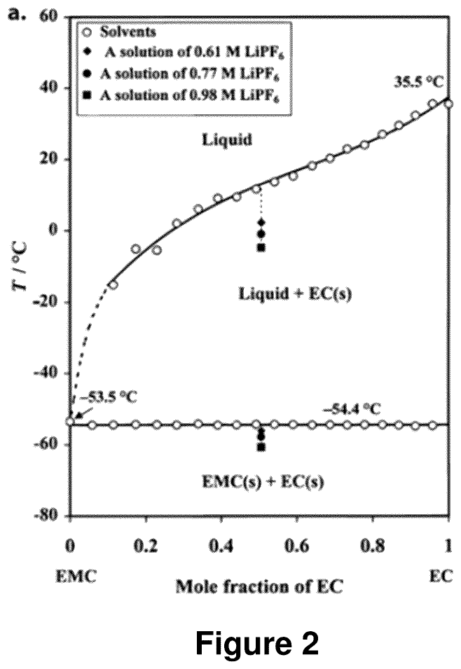

FIG. 3 illustrates the block diagram of the first basic back-up power source embodiment of the present invention with integrated high-frequency current battery electrolyte heating system for a line powered system operation with uninterrupted power at power outages, including in very cold environments.

FIG. 4 illustrates the block diagram of the “Control System” component of the first back-up power source embodiment of FIG. 3 showing its basic components and their connection to the other components of the back-up power source.

FIG. 5 illustrates the block diagram of the “High-Frequency Battery and Super-capacitor Heater” of FIG. 3 showing its basic components and their connection to the other components of the back-up power source.

### DETAILED DESCRIPTION

A recently developed technology uses high frequency current to directly heat battery electrolyte and super-capacitors (See U.S. Pat. Nos. 10,063,076; 10,855,085; 11,211,809; 11,211,810; 11,594,908; 12,074,301, as well as U.S. Patent Application Publication Nos. 2020/0176835; 2021/0304972; 2021/0307113; 2022/0113750;; 2023/0344029; 2024/0136616; 2023/0359231 and U.S. patent application Ser. No. 18/244,275, the entire contents of each of which are incorporated herein by reference). This method has been used for direct and rapid heating of battery electrolyte at low temperatures and maintaining the battery temperature at its optimal performance level. The technology has been extensively tested on a wide range of primary and secondary batteries at temperatures as low as −60° C. without causing any damage to the batteries. The technology is applicable to almost all primary and secondary batteries, such as Lithium-ion, Lithium-polymer, NiMH and lead-acid batteries. The technology is also applicable to super-capacitors and has been used to rapidly heat super-capacitors at temperatures as low as −54° C. without any damage.

The technology is based on direct heating of the battery electrolyte using appropriately formed high frequency AC currents that have no or negligible DC component. This technology takes advantage of the electrical characteristics of the batteries and super-capacitors to heat the electrolyte directly and very rapidly to its optimal operating temperature without causing any damage.

The developed electrolyte heating units are externally powered and can heat the battery electrolyte even when the battery temperature is very low, and the battery is unable to provide an effective and usable level of power. The battery may be heated when fully charged or discharged.

The developed electrolyte heating units are inherently highly efficient and safe and can be readily integrated into the battery safety and protection circuitry and battery chargers.

The following are some of the main characteristics of this technology that make it suitable for the disclosed embodiments of the present invention:
It requires no modification to the battery and super-capacitor.
The basic physics of the process and extensive tests clearly show no damage to the battery and super-capacitor.
The battery pack protection electronic units, such as those for Lithium-ion and Lithium-polymer batteries, can still be used to ensure continuous high-performance operation at low temperatures.
The battery electrolyte and super-capacitor is directly and uniformly heated, therefore bringing a very cold battery to its optimal operating temperature very rapidly and minimizing heat loss from the battery.
Direct electrolyte heating requires significantly less electrical energy than external heating such as with the use of heating blankets.
Standard sized Li-ion or Li-polymer batteries can be used instead of thin and flat battery stack packaging to accelerate external heating via heating blankets or the like.
The technology is simple to implement and low-cost.

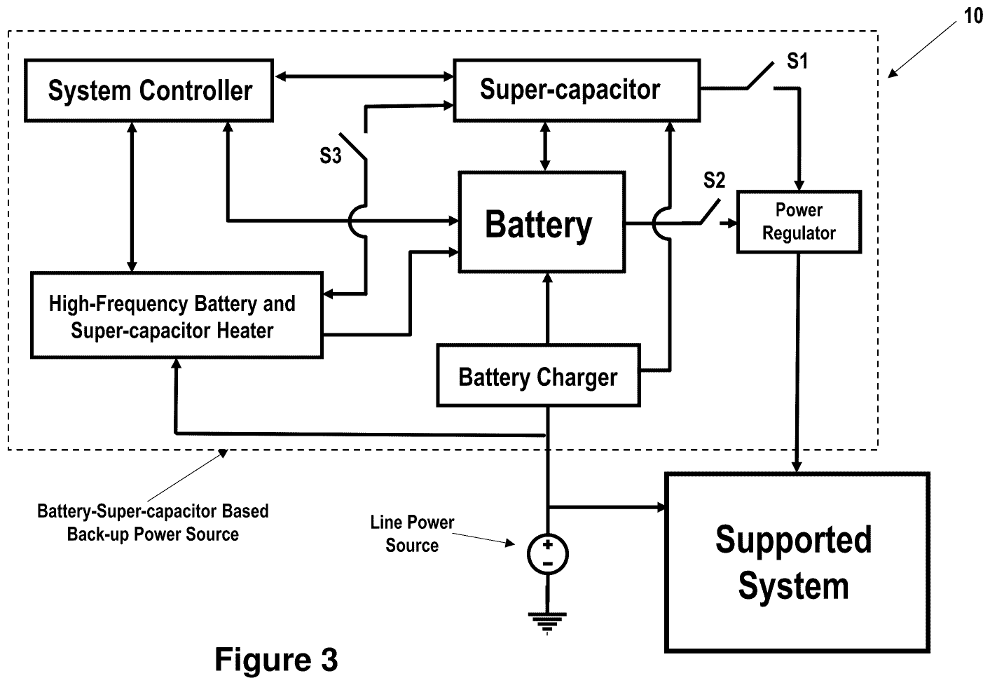

FIG. 3 shows the block diagram of the basic back-up power source system embodiment 10 for operation in any environment, including in cold and extremely cold environments with low operational cost (hereinafter also referred to as “Back-up Power Source System”. The back-up power source system embodiment 10 of FIG. 3 is seen to be powered by line power while the line power is available.

The electrical energy storage component of the back-up power source system embodiment 10 of FIG. 3 consists of a “Battery” (usually one or more battery packs, hereinafter to be referred to as just a “Battery”) and a “Super-capacitor” (also usually a set that are properly connected in series and in parallel to provide the required output voltage and current, hereinafter referred to as just a “Super-capacitor”). The back-up power source system embodiment 10 is also provided with a “Battery Charger” and a “High-Frequency Battery and Super-capacitor Heater” components, both of which are powered by the indicated line power source. The “Battery Charger” is used to charge both the “Battery” and the “Super-capacitor”. The “Super-capacitor” heating by the “High-Frequency Battery and Super-capacitor Heater” may be powered by the line power when available or may be powered by the “Battery” as will be described later. In the block diagram of FIG. 3, the “Battery Charger” and the “High-Frequency Battery and Super-capacitor Heater” components are drawn as separate units but can be integrated into a single unit. In case of a line power outage, the back-up power source system 10 provides power to the “Supported System”, usually through a provided “Power Regulator” unit.

The “Battery Charger” component is configured and constructed like any of the currently available high current chargers with the well-known safety and current, voltage, temperature, etc., controls. The “High-Frequency Battery and Super-capacitor Heater” component is also configured and constructed as described in the U.S. Patents and Patent Applications listed above and incorporated herein by reference.

In back-up power source system embodiment 10 of FIG. 3, the system controller has the task of operating the system. The basic components of the system controller and its operation is described later in this disclosure.

The details of the configuration and operation of the back-up power source system embodiment 10 of FIG. 3 are described below. It is appreciated that not all minor components of the system, such as temperature sensors and the like and their connections to the various components of the back-up power source system are shown in the block diagram of FIG. 3 and will be illustrated and described later in this disclosure.

The basic operation of the back-up power source system embodiment 10 of FIG. 3 is as follows. In normal conditions, i.e., while line power is available, the “Supported System” is directly powered by the line power. In addition, line power has also been used to charge the back-up power source system “Battery” and “Super-capacitor” units as is described later. Then in the event of line power outage (i.e., no power or less power than necessary to power the supported system), the “Controller” would detect the outage event and begin to immediately provide power to the “Supported System” from the “Super-capacitor” and if the “Battery” temperature is at or close to its optimal operating temperature, from the “Battery”. However, if the “Battery” temperature is below its optimal range, then the “Super-capacitor” would power the “Supported System” as well as heat the “Battery” to its optimal operating temperature range via the “High-Frequency Battery and Super-Capacitor Heater” as it will be described in more detail later. Then once the “Battery” temperature has reached it optimal operational level, then the “Supported System” will start to be powered by the “Battery”. In either case, the provided power is transmitted from the “Super-capacitor” and the “Battery” through a “Power Regulator” to the requirements of the “Supported System”.

The “High-Frequency Battery and Super-Capacitor Heater” would usually comprise more than one circuit to accommodate line power or “Super-capacitor” or “Battery” power for either “Battery” or “Super-capacitor” heating function as is described in more detail later.

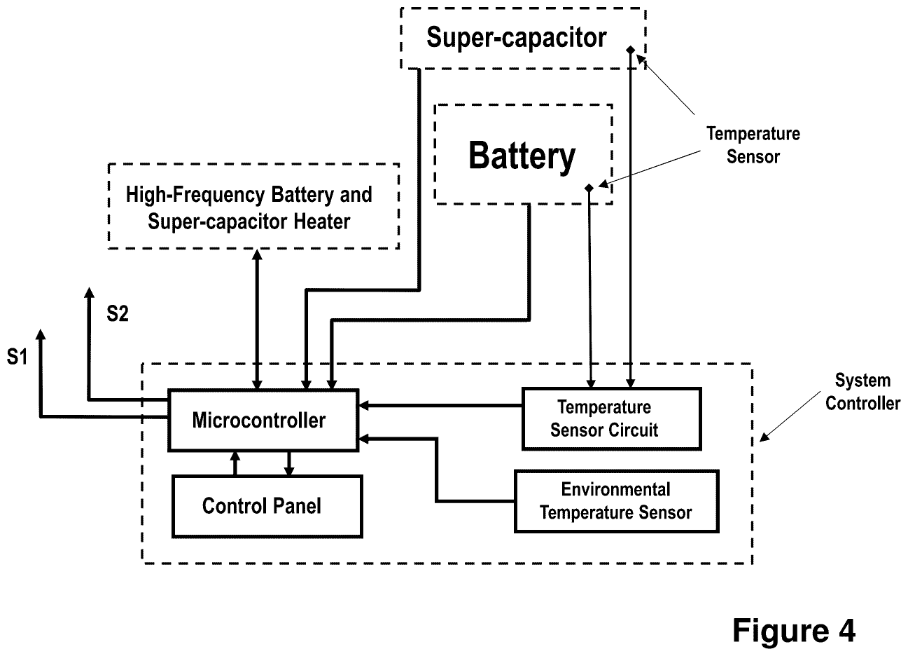

FIG. 4 illustrates the block diagram of the “Control System” component of the first back-up power source system embodiment 10 of FIG. 3 showing its basic components and their connection to the other components of the back-up power source. As can be seen in FIG. 4, the main component of the “System Controller” of the back-up power source system embodiment 10 is the “Microcontroller”, which is programmed to perform the various tasks of the back-up power source system as is described later in this disclosure. The “System Controller” is provided with a “Control Panel”, which is provided with communication links and may equipped with various means of communication, such as manual inputs, ethernet input, means of wireless communications, etc., depending on the application.

The “System Controller” is also provided with the means to receive input from the “Battery” and “Super-capacitor” temperature sensors, indicated as the “Temperature Sensor Circuit” block in FIG. 4, which transferred the detected temperatures to the “Microcontroller” unit of the “System Controller”. In certain applications, as is later described, the environmental temperature is also required or is used as a reference for operational decisions by the “System Controller”. As can be seen in the block diagram of FIG. 4, the measured environmental temperature by the “Environmental Temperature Sensor”, which may be positioned inside or outside of the “System Controller” component housing, is also provided to the “Microcontroller” of the “System Controller”.

The “System Controller” is powered by the “Battery” or the “Super-capacitor” as shown in the block diagram of FIG. 4. The “Microcontroller” is also connected to the “High-Frequency Battery and Super-capacitor Heater” to direct its operation in heating the “Battery” and/or the “Super-Capacitor” and detect the status of the line power, which is used to power the “High-Frequency Battery and Super-capacitor Heater” when line power is available as later described.

The operation of the back-up power source system embodiment 10 of FIG. 3 is controlled by the provided programmable “Microcontroller”, FIG. 4. The temperature of the “Battery” is measured by a provided “Temperature Sensor”, which may be a well-known thermocouple or thermistor or the like, the output of which is provided to the “Microcontroller” via an appropriate “Temperature Sensor Circuit”, FIG. 4. A similar “Temperature Sensor” is also provided to measure the temperature of the “Super-capacitor” and the information is similarly transmitted to the “Temperature Sensor Circuit” and from there to the “Microcontroller”. In general, also provided is an “Environmental Temperature Sensor” for measuring environmental temperature of the back-up power source system and provide the information to the “Microcontroller” for setting an optimal process for the operating the back-up power source system as described later in this disclosure.

The back-up power source system embodiment 10 of FIG. 3 operates as follows depending on each possible condition that it being faced. It is appreciated that the different operational conditions are defined based on the current state of the line power; the temperatures of the “Battery” and the “Super-Capacitor” and their states of charge.

### Case One

In this case, the line power is on. Both “Battery” and “Super-capacitor” are fully charged, and their temperatures are at or an allowable amount above their optimal operational temperature. It is appreciated that in general, the operational temperature of battery and super-capacitor is considered optimal around 20°-23° C. It is also appreciated that since operation of the back-up power source system may be compromised in cold environment, operation of this system in hot environments, i.e., operation at temperatures above the safe operating temperature of the “Battery” or “Super-capacitor”, e.g., provision of their cooling methods and systems, is not addressed herein.

In this case, when the line power is cut, the “Microcontroller” detects the outage through one of the commonly used line power detection methods used in the art, through its direct connection to the line power (not shown) or through its line power connection to the “High-Frequency Battery and Super-capacitor Heater” connection to the line power, and closes the switches S1 and S2, FIGS. 3 and 4, and almost instantaneously begin to supply power to the “Supported System” via the “Power Regulator”. It is appreciated that the “Power Regulator” is configured using one of the well-known circuits in the art and the required components to supply the proper power level at the required voltage to the “Supported System”, as well as provide the power from both “Battery” and “Super-capacitor”, together or sequentially, or the like, depending on the “Supported System” requirements. For example, if a nearly constant power level is needed or if there is a need for short high current supply pulses, then the “Super-capacitor” is the proper candidate to supply the power. The size and type of the “Battery” and the “Super-capacitor” are obviously selected to match the “Supported System” requirements and the expected length of line power outage.

It is appreciated that once line power is restored, the switches S1 and S2 are opened by the “Microcontroller” following its detection as was previously described. Now if the “Battery” and “Super-capacitor” temperatures are at or above their optimal charging temperatures, then the “Microcontroller” commands the “Battery Charger” to begin to fully charge the “Battery” and the “Super-capacitor” (directly as shown in the block diagram of FIG. 3 or via the “Battery” power). Otherwise, the “Microcontroller” commands the “High-Frequency Battery and Super-capacitor Heater” to begin to heat the “Battery” and the “Super-capacitor” to their optimal temperature level. The “Microcontroller” would then command the “Battery Charger” to begin to fully charge the “Battery” and the “Super-capacitor”.

The back-up power source system embodiment 10 of FIG. 3 is then set to its initial conditions, i.e., maintaining the “Super-capacitor” temperature at its optimal operating condition and ensuring that the “Battery” temperature does not drop below its prescribed level, for example, below −50° C. for Lithium-ion battery pack based “Battery”.

### Case Two

In this case, the line power is on. Both “Batter” and “Super-capacitor” are fully charged. The environmental temperature is low, i.e., below the optimal operational temperatures of the “Battery” and the “Super-capacitor”.

It is appreciated that once the environmental temperature becomes low, the “Battery” and “Super-capacitor” temperatures would also drop and at some point, move below their optimal operating temperatures. Once this happens, the “Microcontroller” would command the “High-Frequency Battery and Super-capacitor Heater” to begin to heat the “Super-capacitor” to (usually a few degrees above) its optimal operating temperature. From this point on, whenever the “Super-capacitor” temperature falls (usually 1-2 degrees C.) below its optimal operating temperature, the “Microcontroller” would command the “High-Frequency Battery and Super-capacitor Heater” to heat the “Super-capacitor” as described above. As a result, as long as the environmental temperature is low, i.e., below the optimal operating temperature of the “Super-capacitor”, the “Microcontroller” would command the “High-Frequency Battery and Super-capacitor Heater” to maintain the “super-capacitor” temperature within a relatively small range of usually around ±2° C. The “Battery” temperature is, however, allowed to drop below its optimal operating temperature.

It is appreciated by those skilled in the art that certain batteries are not supposed to be subjected to temperatures below certain levels. For example, Lithium-ion batteries are usually suggested not to be subjected to temperatures below −60° C. Therefore, when the environmental temperature gets close to such prescribed low limits, for example, when the batteries used to fabricate the battery pack, i.e., the “Battery” of the back-up power source embodiment 10 of FIG. 3, then the “Microcontroller” would engage the “High-Frequency Battery and Super-capacitor Heater” to keep the “Battery” temperature above a prescribed low limit, for example, within −55° C. and −50° C. for Lithium-ion battery pack based “Battery”. It is appreciated in environments that the temperature is not extremely cold, in this case, the temperature is above −50° C., the “Microcontroller” would not command the “High-Frequency Battery and Super-capacitor Heater” to heat the “Battery”.

In this case, when the line power is cut, the “Microcontroller” detects the outage as was previously described. The “Microcontroller” would then close the switch S1, FIGS. 3 and 4, and almost instantaneously begin to supply power to the “Supported System” by the “Super-capacitor” via the “Power Regulator”. At the same time, the “Microcontroller” closes the switch S3, FIG. 3, to provide power to the “High-Frequency Battery and Super-capacitor Heater” from the “Super-capacitor”, and for the “High-Frequency Battery and Super-capacitor Heater” to begin to heat the “Battery” to its optimal operating temperature.

It is appreciated that “High-Frequency Battery and Super-capacitor Heaters” are designed to rapidly heat batteries with high efficiency. It is also appreciated that the electrical energy capacity of the “Super-capacitor” of the back-up power source system is configured to provide enough electrical energy to satisfy the power requirement of the “Supported System” during expected line power outages as well as the electrical energy required to heat the “Battery” from the expected cold temperature to its optimal operational temperature.

Then, once the “Battery” temperature has been raised to its optimal operational level, the “Microcomputer” would close the switch S2, FIGS. 3 and 4, and the “Battery” would join the “Super-capacitor” to supply power to the “Supported System” via the “Power Regulator”. It is appreciated that the “Power Regulator” is designed using any one of the well-known circuits in the art and the required components to supply the proper power level at the required voltage to the “Supported System”, as well as provide the power from both “Battery” and “Super-capacitor”, together or sequentially, or the like, depending on the “Supported System” requirements. For example, if a nearly constant power level is needed or if there is a need for short high current pulses, then the “Super-capacitor” is the proper candidate to supply the power. The size and type of the “Battery” and the “Super-capacitor” are obviously selected to match the “Supported System” requirements and the expected length of line power outage.

It is appreciated that once line power is restored, the switches SI and S2 are opened by the “Microcontroller” following its detection as was previously described. Now if the “Battery” and “Super-capacitor” temperatures are at or above their optimal charging temperatures, then the “Microcontroller” commands the “Battery Charger” to begin to fully charge the “Battery” and the “Super-capacitor” (directly as shown in the block diagram of FIG. 3 or via the “Battery” power). Otherwise, the “Microcontroller” commands the “High-Frequency Battery and Super-capacitor Heater” to begin to heat the “Battery” and the “Super-capacitor” to their optimal temperature level. The “Microcontroller” would then command the “Battery Charger” to begin to fully charge the “Battery” and the “Super-capacitor”.

The back-up power source system embodiment 10 of FIG. 3 is then set to its initial conditions, i.e., maintaining the “Super-capacitor” temperature at its optimal operating condition and ensuring that the “Battery” temperature does not drop below its prescribed level, for example, below −50° C. for Lithium-ion battery pack based “Battery”.

It is also appreciated that while the “Battery” and/or “Super-capacitor” is powering the “Supported System”, if the temperature of either unit falls below a prescribed level that would prevent optimal level of powering of the “Supported System”, then the “Microcontroller” would command the “High-Frequency Battery and Super-capacitor Heater” to heat the affected unit using its own power.

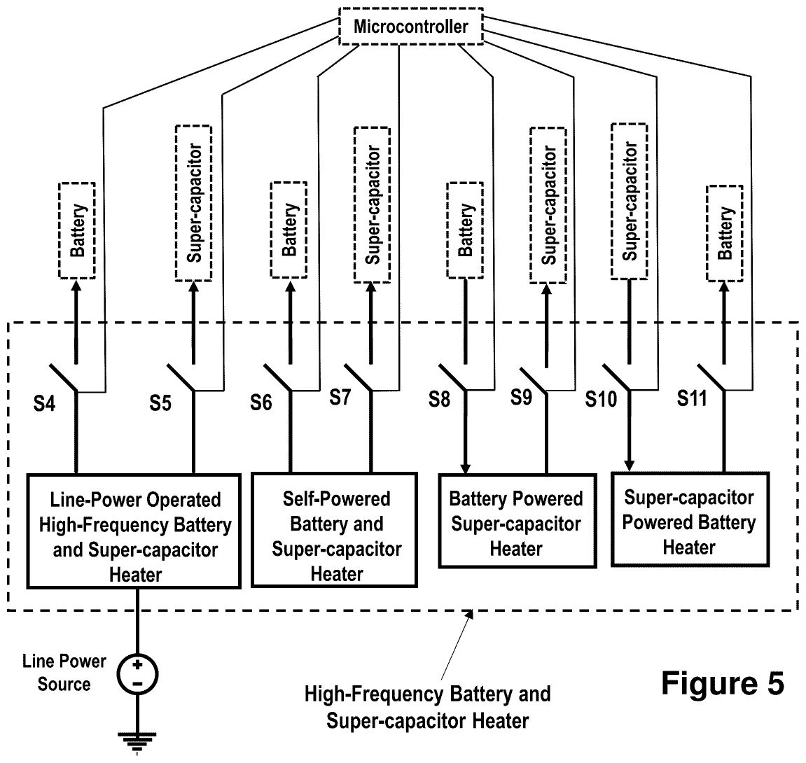

In the above two cases, the “Microcontroller” controls the operation of the “High-Frequency Battery and Super-capacitor Heater”. FIG. 5 illustrates the block diagram of the “High-Frequency Battery and Super-capacitor Heater” component of the back-up power source system embodiment 10 of FIG. 3, showing its basic components and connection to the other components of the back-up power source. The various heating circuit units of each component of the “High-Frequency Battery and Super-capacitor Heater” are configured as described in the above listed U.S. Patents and Patent Applications, which have been incorporation by reference.

As can be seen in FIG. 5, the “High-Frequency Battery and Super-capacitor Heater” consists of the following four main components:
1—Line-Power Operated High-Frequency Battery and Super-capacitor Heater: This component of the “High-Frequency Battery and Super-capacitor Heater” is powered by line power as is obviously used only when line power is available and the back-up power source system embodiment 10 of FIG. 3 is not powering the “Supported System”. This component generally has two operational modes. One for heating the “Battery” and the other for heating the “Super-capacitor”. When the “Battery” temperature drops below a certain limit that can damage the battery as was previously described, for example below −50° C. for most currently available Lithium-ion batteries, then the “Microcontroller” would close the switch S4 and command the “Line-Power Operated High-Frequency Battery and Super-capacitor Heater” to begin to heat the battery to a prescribed temperature, for example to −30° C., after which time the switch S4 is opened and the “Battery” heating would cease. Similarly, when the “Super-capacitor” temperature drops below its optimal operating temperature, the “Microcontroller” would close the switch S5 and command the “Line-Power Operated High-Frequency Battery and Super-capacitor Heater” to begin to heat the “Super-capacitor”. It is appreciated that as it is shown in the block diagram of FIG. 4, the “Microcontroller” monitors the temperatures of both the “Battery” and the “Super-capacitor”.
2—Self-Powered Battery and Super-capacitor Heater: The function of this component of the “High-Frequency Battery and Super-capacitor Heater” is to keep the temperatures of the “Battery” and “Super-capacitor” close to their optimal operating conditions while the line power is not available. In general, the “Super-capacitor” power is spent while initially supplying power to the “Supported System” and powering the heating of the “battery” to its optimal operational temperature. The “Microcontroller”, as it monitors the temperatures of the “Battery” and the “Super-capacitor” and detects their available electrical energy, would close the switch S6 to allow the “Battery” to use the self-heating circuit of the “Self-Powered Battery and Super-capacitor Heater” to maintain the “Battery” temperature at its optimal level. The “Microcontroller” would also close the switch S7 when needed to use the self-heating circuit of the “Self-Powered Battery and Super-capacitor Heater” to maintain the “Super-capacitor” temperature at its optimal level
3—Battery Powered Super-capacitor Heater: The function of this component of the “High-Frequency Battery and Super-capacitor Heater” is to use “Battery” power to heat the “Super-capacitor” to its optimal temperature while both “Battery” and “Super-capacitor” are supplying power to the “Supported System” following line power outage. The heating of the “super-capacitor” may be needed if the “Super-capacitor” still has enough stored electrical energy to supply to the “Supported System”. To perform this task, the “Microcontroller” would close the switch S8 to power the “Battery Powered Super-capacitor Heater” and close the switch S9 to supply the generated high-frequency heating current to the “Super-capacitor”.
4—Super-capacitor Powered Battery Heater: The main function of this component of the “High-Frequency Battery and Super-capacitor Heater” is in cold temperatures when the “Battery” temperature is below its optimal operating temperature and then line power is suddenly cut. When this happens, the “Microcontroller” would immediately close the switch S1, FIG. 3, so that the “Super-capacitor” would immediately begin to provide power to the “Supported System” as was previously described and would also begin to heat the “Battery” to its optimal operating temperature. This is done by the “Microcontroller” closing the switch S10 to power the “Super-capacitor Powered Battery Heater” and closing the switch S11 to supply the generated high-frequency heating current to the “Battery” until its temperature is raised to its optimal operating temperature.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. A back-up power source system for a supported system, the back-up power source system comprising:
a battery;
a super-capacitor;
a battery charger configured to charge one or more of the battery and the super-capacitor using a line power source; and
a controller comprising hardware, the controller being configured to:
monitor the power supply from the line power source;
monitor a temperature of one or more of the battery and the super-capacitor;
when power is available through the line power source:
supply power directly from the line power source to the supported system; and
supply power directly to the charger to charge the battery and the super-capacitor; and
in the event of a detected line power outage, supply power to the supported system from one or more of the battery and super-capacitor based at least on the detected temperature of the one or more of the battery and super-capacitor.

2. The back-up power source system of claim 1, further comprising a high-frequency battery and super-capacitor heater configured to heat one or more of the battery and the super-capacitor to a predetermined temperature by input of a high-frequency AC current;
wherein:
in the event of a detected line power outage, if the temperature of one or more of the battery is detected to be above a first predetermined temperature, and the super-capacitor is detected to be above a second predetermined temperature, provide power from one or more of the battery and the super-capacitor to the supported system; and
if the temperature of one or more of the battery is detected to be below the first predetermined temperature and the super-capacitor is detected to be below the second predetermined temperature, control the high-frequency battery and super-capacitor heater to heat one or more of the battery and the super-capacitor.

3. The back-up power source system of claim 2, wherein when the outage is detected, the super-capacitor is above the second predetermined temperature and the battery is below the first predetermined temperature; and
the controller is further configured to:
control the super-capacitor to provide power to the supported system:
control the super-capacitor to provide power to the high-frequency battery and super-capacitor heater to heat the battery above the first predetermined temperature; and
subsequent to the battery being heated above the first predetermined temperature, supply power to the supported system from the battery.

4. The back-up power source system of claim 1, further comprising a power regulator for selectively transmitting the super-capacitor power from the super-capacitor through a first switch to the supported system and the battery power from the battery through a second switch to the supported system.

5. The back-up power source system of claim 1, wherein the controller is further configured to, in the event of the detected line power outage, provide power from one or more of the battery and super-capacitor to the controller.

6. The back-up power source system of claim 1, wherein the controller is further configured to receive input from one or more of a battery temperature sensor and a super-capacitor temperature sensor.

7. The back-up power source system of claim 1, further comprising a high-frequency battery and super-capacitor heater configured to heat the battery to a first predetermined temperature and the super-capacitor to a second predetermined temperature by input of a high-frequency AC current;
wherein when, subsequent to supplying power to the supported system from one or more of the battery and super-capacitor, the power through the line power source is restored;
where the temperature of one or more of the battery is above the first predetermined temperature and supercapacitor is above the second predetermined temperature when the power through the line power source is restored, controlling the charger to charge the one or more of the battery and the super-capacitor using the line power source; and
where the temperature of one or more of the battery is below the first predetermined temperature and supercapacitor is below the second predetermined temperature when the power through the line power source is restored, controlling the high-frequency battery and super-capacitor heater to heat the one or more of the battery to a temperature above the first predetermined temperature and the super-capacitor to a temperature above the second predetermined temperature.

8. The back-up power source system of claim 1, further comprising a high-frequency battery and super-capacitor heater configured to heat the battery to a first predetermined temperature and the super-capacitor to a second predetermined temperature by input of a high-frequency AC current;
wherein the controller is further configured to substantially maintain the first and second predetermined temperatures of one or more of the battery and super-capacitor, respectively, using the high-frequency battery and super-capacitor heater powered by the line power source when power is available through the line power source.

9. The back-up power source system of claim 1, further comprising a high-frequency battery and super-capacitor heater configured to heat the battery to a first predetermined temperature and the super-capacitor to a second predetermined temperature by input of a high-frequency AC current;
wherein the controller is further configured to substantially maintain the first and second predetermined temperatures of one of the battery and super-capacitor, respectively, using the high-frequency battery and super-capacitor heater powered by the other of the battery and super-capacitor when power is available through the line power source.

10. The back-up power source system of claim 9, wherein the controller maintains the first and second predetermined temperatures of one of the battery and super-capacitor, respectively, when a detected environmental temperature of one of the battery and super-capacitor is below a predetermined environmental temperature.

11. The back-up power source system of claim 1, further comprising a high-frequency battery and super-capacitor heater configured to heat the battery and the super-capacitor to a predetermined temperature by input of a high-frequency AC current, wherein the high-frequency battery and super-capacitor heater comprises:
a first high-frequency heater powered by the line power source;
a second high-frequency battery powered by battery to heat the battery and powered by the super-capacitor to heat the super-capacitor;
a third high-frequency heater powered by the battery to heat the super-capacitor; and
a fourth high-frequency heater powered by the super-capacitor to heat the battery.

11. The back-up power source system of claim 1, wherein, in the event of the detected line power outage, the supplying of power to the supported system from one or more of the battery and super-capacitor is further based on, at least initially, on power requirements for the supported system.

12. A processing apparatus comprising:
a controller comprising hardware, the controller being configured to:
monitor a power supply from a line power source;
monitor a temperature of one or more of a battery and a super-capacitor;
when power is available through the line power source:
supply power directly from the line power source to the supported system; and
supply power directly to the charger to charge the battery and the super-capacitor; and
in the event of a detected line power outage, supply power to the supported system from one or more of the battery and super-capacitor based at least on the detected temperature of the one or more of the battery and super-capacitor.

13. The processing apparatus of claim 13, wherein
in the event of a detected line power outage, if the temperature of one or more of the battery is detected to be above a first predetermined temperature, and the super-capacitor is detected to be above a second predetermined temperature, provide power from one or more of the battery and the super-capacitor to the supported system; and
if the temperature of one or more of the battery is detected to be below the first predetermined temperature and the super-capacitor is detected to be below the second predetermined temperature, control the high-frequency battery and super-capacitor heater to heat one or more of the battery and the super-capacitor.

14. The processing apparatus of claim 13, wherein
wherein when the outage is detected, the super-capacitor is above the second predetermined temperature and the battery is below the first predetermined temperature; and
the controller is further configured to:
control the super-capacitor to provide power to the supported system:
control the super-capacitor to provide power to the high-frequency battery and super-capacitor heater to heat the battery above the first predetermined temperature; and
subsequent to the battery being heated above the first predetermined temperature, supply power to the supported system from the battery.

15. A method comprising:
monitoring a power supply from a line power source;
monitoring a temperature of one or more of a battery and a super-capacitor;
when power is available through the line power source:
supplying power directly from the line power source to the supported system; and
supplying power directly to the charger to charge the battery and the super-capacitor; and
in the event of a detected line power outage, supplying power to the supported system from one or more of the battery and super-capacitor based at least on the detected temperature of the one or more of the battery and super-capacitor.

16. The method of claim 15, wherein
in the event of a detected line power outage, if the temperature of one or more of the battery is detected to be above a first predetermined temperature, and the super-capacitor is detected to be above a second predetermined temperature, provide power from one or more of the battery and the super-capacitor to the supported system; and
if the temperature of one or more of the battery is detected to be below the first predetermined temperature and the super-capacitor is detected to be below the second predetermined temperature, control the high-frequency battery and super-capacitor heater to heat one or more of the battery and the super-capacitor.

17. method of claim 16, wherein
wherein when the outage is detected, the super-capacitor is above the second predetermined temperature and the battery is below the first predetermined temperature; and
the method further comprises:
controlling the super-capacitor to provide power to the supported system:
controlling the super-capacitor to provide power to the high-frequency battery and super-capacitor heater to heat the battery above the first predetermined temperature; and
subsequent to the battery being heated above the first predetermined temperature, supplying power to the supported system from the battery.

18. A back-up power source system for a supported system, the back-up power source system comprising:
a battery;
a super-capacitor;
a battery charger configured to charge one or more of the battery and the super-capacitor using a line power source; and
a controller comprising hardware, the controller being configured to:
monitor the power supply from the line power source;
when power is available through the line power source:
supply power directly from the line power source to the supported system; and
supply power directly to the charger to charge the battery and the super-capacitor; and
in the event of a detected line power outage, at least initially, supply power to the supported system from one of the battery and super-capacitor based at least on power requirements for the supported system.

19. The back-up power source system of claim 18, wherein the power requirements includes one or more of whether the supported system requires a constant power level and short high current power supply pulses.

20. The back-up power source system of claim 18, further comprising:
one or more of:
a battery temperature sensor for monitoring a first temperature of the battery; and
a super-capacitor battery temperature sensor for monitoring a second temperature of the super-capacitor; and
a high-frequency battery and super-capacitor heater configured to heat one or more of the battery and the super-capacitor to a first and a second predetermined temperature, respectively, by input of a high-frequency AC current when one or more of the first temperature is below the first predetermined temperature and the second temperature is below the second predetermined temperature.
